(19) United States
(12) Patent Application Publication
(10) Pub. No.: US 2019/0242769 A1
(43) Pub. Date: Aug. 8, 2019

(54) TORQUE ADAPTER

(71) Applicant: TTI (MACAO COMMERCIAL OFFSHORE) LIMITED, Macau (MO)

(72) Inventors: Michael S. Brue, Anderson, SC (US); Julia H. Moylan, Anderson, SC (US)

(21) Appl. No.: 15/887,022

(22) Filed: Feb. 2, 2018

(51) Int. Cl. G01L 5/24; G01L 3/18

(52) U.S. Cl. CPC G01L 5/24; G01L 3/18

(57) ABSTRACT

A torque adapter for measuring a stall torque supplied by a rotary power source includes a housing, a mandrel rotatable relative to the housing, and a resistance subassembly. The housing includes an arcuate recess defined at least partially by a recess front wall a recess back wall. The arcuate recess includes a first rotational zone bounded on one side by the recess front wall, and a second rotational zone bounded on an opposite side by the recess back wall. The mandrel includes a flange portion having an arcuate protrusion received in the arcuate recess. The resistance subassembly includes a biasing member and is received into the arcuate recess. When the mandrel is rotated relative to the housing, the mandrel encounters nominal rotational resistance while the arcuate protrusion passes through the first rotational zone, and the mandrel encounters increasing rotational resistance while the arcuate protrusion passes through the second rotational zone.

### FIELD OF THE INVENTION

The present invention relates to devices for measuring a maximum torque supplied by a rotary power source, and more particularly to a torque adapter useful to more accurately measure the stall torque of a rotary power tool.

### BACKGROUND OF THE INVENTION

Rotary power tools are typically capable of supplying a maximum torque when the rotational output is stalled. The maximum torque that a given rotary power tool can supply is subject to internal resistive forces, such as the frictional resistance of an electric motor and the frictional resistance of a drivetrain assembly.

### SUMMARY OF THE INVENTION

The present invention provides, in one aspect, a torque adapter for measuring a stall torque supplied by a rotary power source. The torque adapter includes a housing, a mandrel rotatable relative to the housing, and a resistance subassembly. The housing includes an arcuate recess defined at least partially by a recess front wall a recess back wall. The arcuate recess includes a first rotational zone bounded on one side by the recess front wall, and a second rotational zone bounded on an opposite side from the first rotational zone by the recess back wall. The mandrel includes a flange portion having an arcuate protrusion received in the arcuate recess. The resistance subassembly includes a biasing member and is received into the arcuate recess. When the mandrel is rotated relative to the housing, the mandrel encounters nominal rotational resistance while the arcuate protrusion passes through the first rotational zone, and the mandrel encounters increasing rotational resistance while the arcuate protrusion passes through the second rotational zone.

The present invention provides, in another aspect, a method of measuring a stall torque supplied by a rotary power source using a torque adapter and a torque transducer. The torque adapter includes a mandrel and a housing. The mandrel is coupled to the rotary power source, and the housing is rotationally fixed to the torque transducer. The method includes a step of activating the rotary power source to supply a torque to the mandrel. Next, the method includes a step of rotating the mandrel relative to the housing through a first rotational zone of nominal rotational resistance. Next, the method includes a step of rotating the mandrel relative to the housing through a second rotational zone of increasing rotational resistance. Next, the method includes a step of stalling rotation of the mandrel when the rotational resistance becomes equal to the torque supplied by the rotary power source. Finally, the method includes a step of measuring the stall torque of the rotary power source with the torque transducer.

Other features and aspects of the invention will become apparent by consideration of the following detailed description and accompanying drawings.

### BRIEF DESCRIPTION OF THE DRAWINGS

FIG. 1 is a schematic view of a torque measurement assembly including a torque adapter in accordance with an embodiment of the invention.

FIG. 2 is a perspective view of the torque adapter of FIG. 1.

FIG. 3 is a side elevation view of the torque adapter of FIG. 1.

FIG. 4 is a cross-sectional view of the torque adapter of FIG. 1 through line 4-4 in FIG. 3.

FIG. 5 is an exploded perspective view of the torque adapter of FIG. 1.

FIG. 6 is another exploded perspective view of the torque adapter of FIG. 1.

FIG. 7 is a cross-sectional view of a housing of the torque adapter of FIG. 1 through line 7-7 of FIG. 3, shown with a first arcuate protrusion in a first, starting orientation.

FIG. 8 is a cross-sectional view of a housing of the torque adapter of FIG. 1 through line 7-7 of FIG. 3, shown with a first arcuate protrusion in a second, intermediate orientation.

FIG. 9 is a cross-sectional view of a housing of the torque adapter of FIG. 1 through line 7-7 of FIG. 3, shown with a first arcuate protrusion in a third, stalled orientation.

FIG. 10 is a cross-sectional view of a housing of the torque adapter of FIG. 1 through line 7-7 of FIG. 3, shown with a first arcuate protrusion in an alternative third, stalled orientation.

FIG. 11 is a flowchart illustrating a method of measuring a stall torque supplied by a rotary power source while utilizing the torque adapter of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

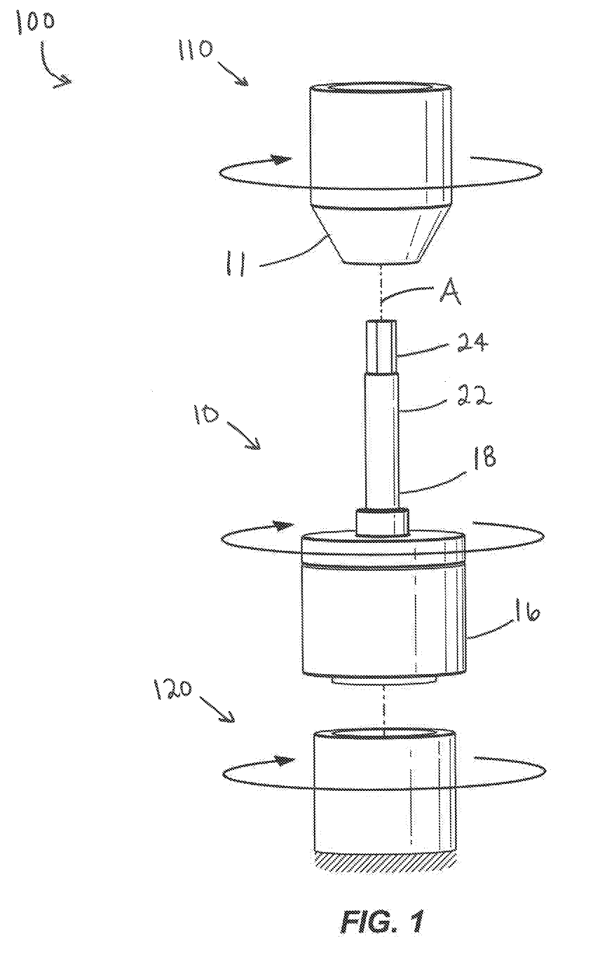

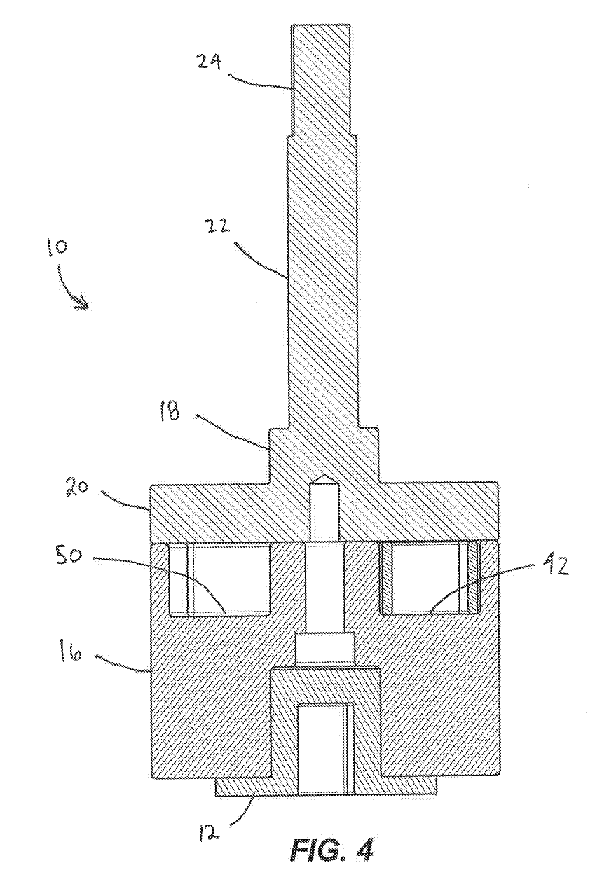

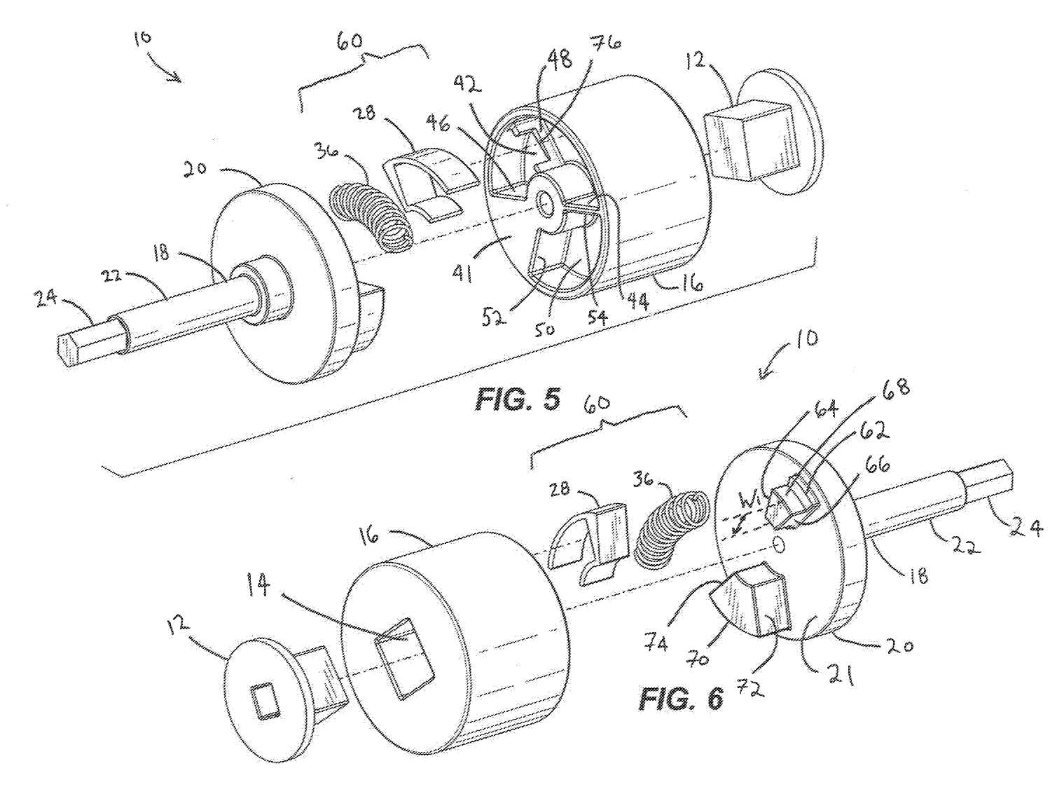

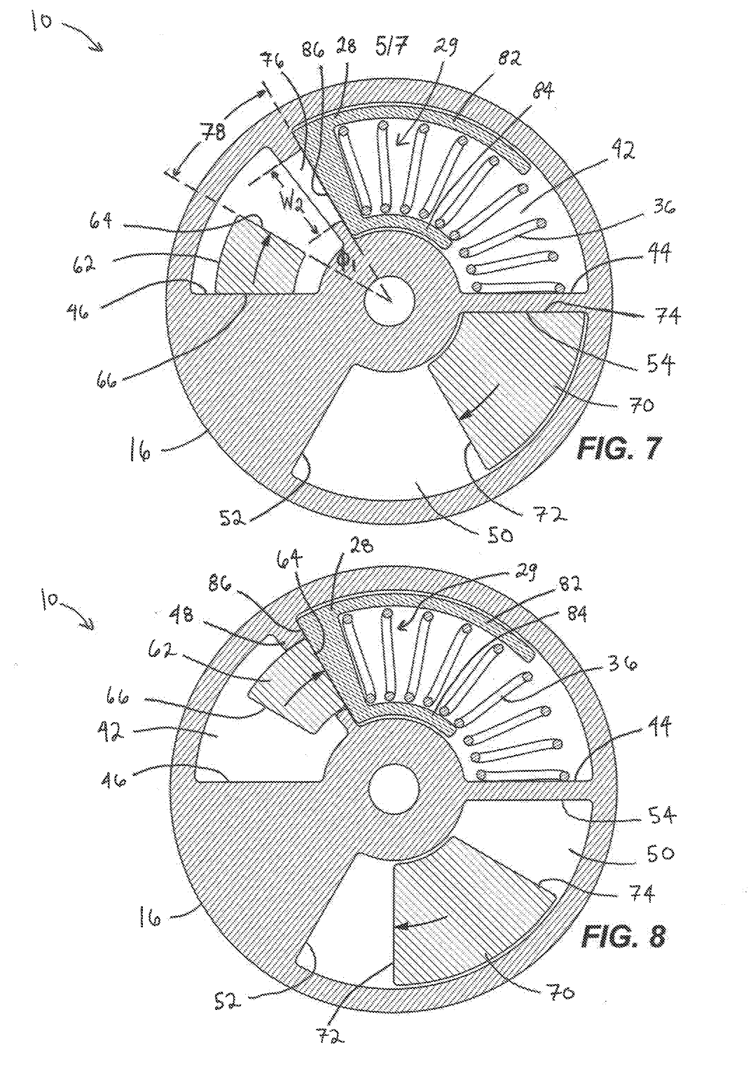

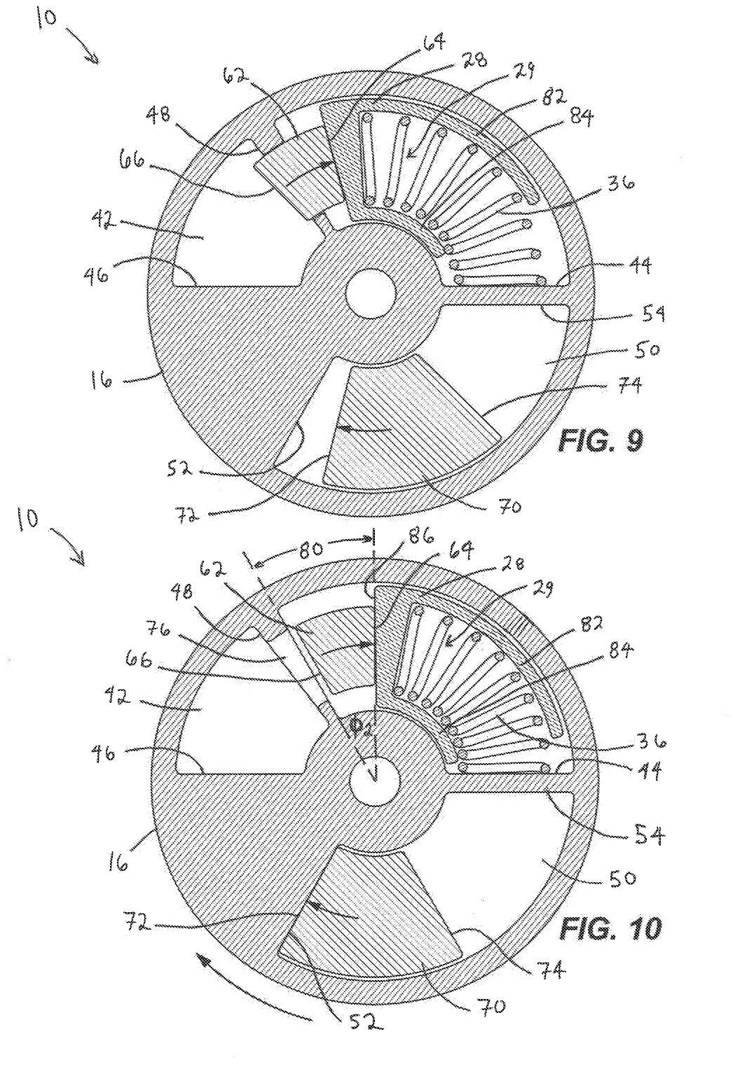

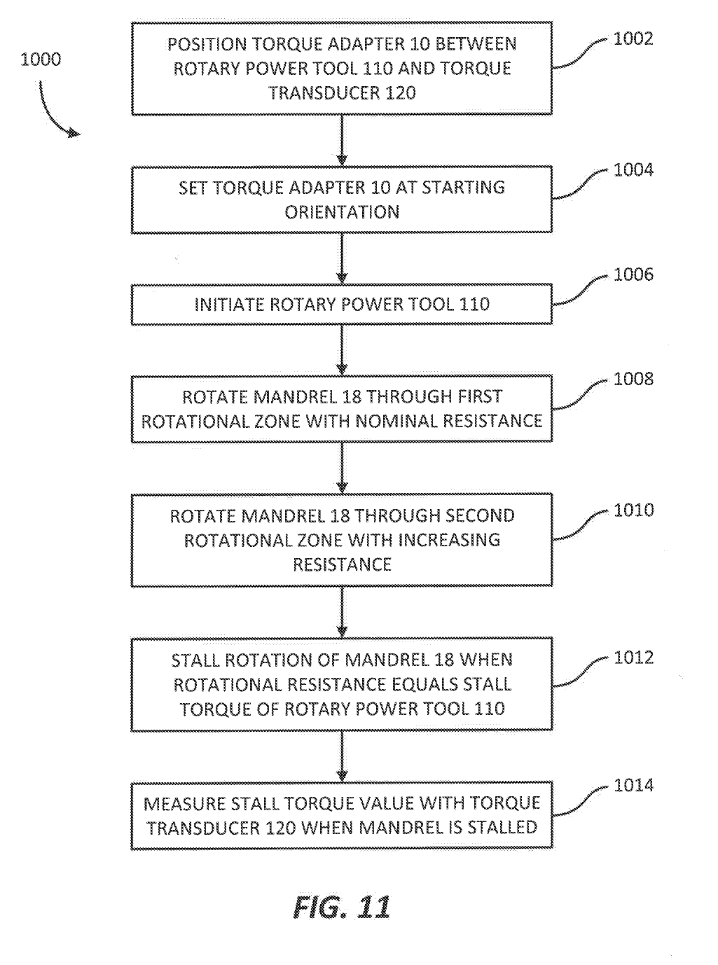

FIGS. 1-9 illustrate a torque adapter 10 useful to more accurately measure a maximum torque (i.e., a stall torque) of a rotary power source, such as a rotary power tool 110. The torque adapter 10 is operable between various rotational orientations, such as a first, starting orientation (FIG. 7), a second, intermediate orientation (FIG. 8), and a third, stalled orientation (FIGS. 9 and 10). The torque adapter 10 includes a cylindrical housing 16 and a mandrel 18 having a spindle portion 22 defining a rotational axis A (FIG. 1). The mandrel 18 is selectively rotatable relative to the housing 16 about the rotational axis A through the various orientations, as described in more detail below. A forward direction of rotation of the mandrel 18 relative to the housing 16 is defined by rotation of the mandrel 18 about the axis A from the starting orientation (FIG. 7) toward the stalled orientation (FIGS. 9 and 10). The torque adapter 10 further includes a resistance subassembly 60 (FIG. 5) within the housing 16.

FIG. 1 illustrates a torque measurement system 100 that includes the torque adapter 10 positioned between a torque output spindle or chuck 11 of the rotary power tool 110 and a torque transducer 120. The torque transducer 120 is rotationally grounded and configured to measure the torque generated by the rotary power tool 110 via the torque adapter 10. The chuck 11 can be associated with the rotary power tool 110 and attachable to the spindle portion 22 of the mandrel 18 so as to be rotatably fixed thereto during operation of the torque measurement system 100. Similarly, the housing 16 includes a first connector (e.g., a female square output recess 14) (FIG. 5) selectively attachable to a second connector (not shown) (e.g., a male square input member) to rotatably fix the housing 16 to the input of the torque transducer 120.

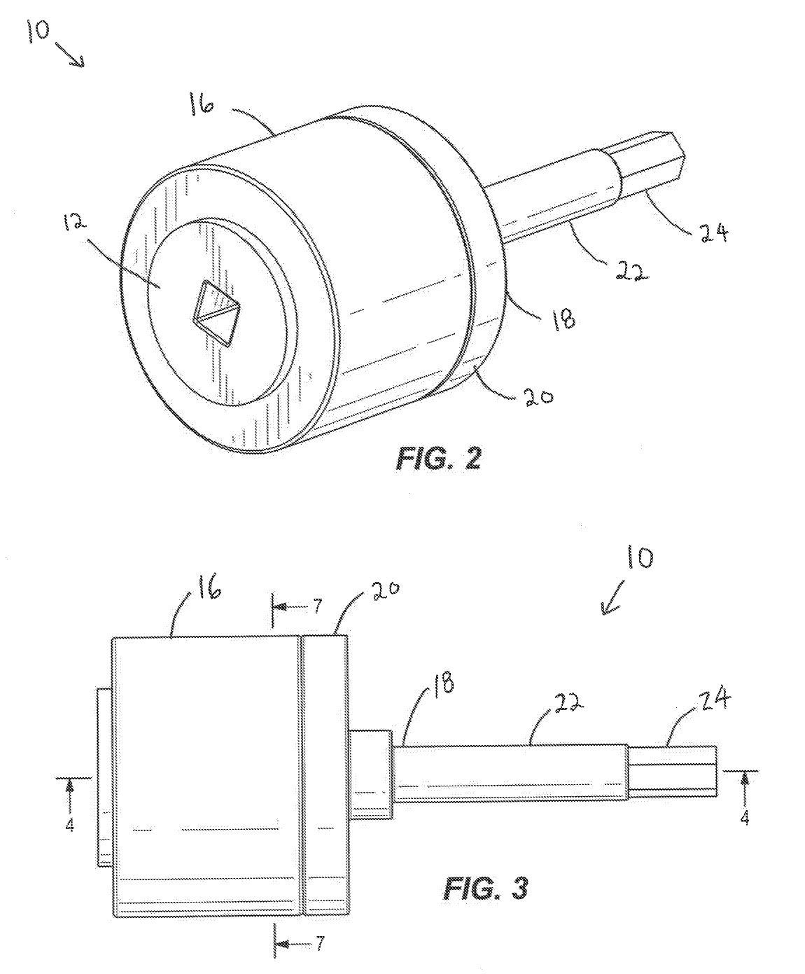

With reference to FIGS. 2-6, the spindle portion 22 of the mandrel 18 includes a hexagonal shank 24 disposed at a distal end of the spindle portion 22 and receivable in the chuck 11 (FIG. 1). A flange portion 20 extends radially outward from a proximal end of the mandrel 18 and defines a first mating surface 21 (FIG. 6).

As best shown in FIG. 6, the mandrel 18 is provided with a first arcuate protrusion 62 projecting axially from the first mating surface 21 and extending at least partially about the circumference of a circle. The first arcuate protrusion 62 includes a first protrusion front wall 64 facing in the forward direction of rotation of the mandrel 18 relative to the housing 16, and a first protrusion back wall 66 opposite the first protrusion front wall 64. In the present construction, the first arcuate protrusion further includes a narrow portion 68 characterized by a decreased radial width W1. The mandrel 18 is further provided with a second arcuate protrusion 70 projecting axially from the first mating surface 21 and extending at least partially about the circumference of a circle. The second arcuate protrusion 70 includes a second protrusion front wall 72 facing in the forward direction of rotation of the mandrel 18 relative to the housing 16, and a second protrusion back wall 74 opposite the second protrusion front wall 72. In the present construction, the first and second arcuate protrusions 62, 70 are rotationally offset by approximately half of a revolution (i.e., 180 degrees) and extend about approximately the same circumference of a circle. In other constructions, the first and second arcuate protrusions 62, 70 can be rotationally offset by less than half of a revolution (e.g., 175 degrees, 160 degrees, 145 degrees, etc.), and can extend about different circumferences.

Referring back to FIG. 5, the housing 16 is provided with a second mating surface 41 located at a proximal end of the housing 16 and configured to mate with the first mating surface 21 of the mandrel 18. A first arcuate recess 42 is disposed in the second mating surface 41 and extends at least partially about a circumference of a circle. The first arcuate recess 42 includes a first recess front wall 44 located at a furthermost end of the first arcuate recess 42 in the direction of rotation, and a first recess back wall 46 opposite the first recess front wall 44. Similarly, a second arcuate recess 50 is disposed in the second mating surface 41 and extends at least partially about a circumference of a circle. The second arcuate recess 50 includes a second recess front wall 52 located at a furthermost end of the second arcuate recess 42 in the direction of rotation, and a second recess back wall 54 opposite the second recess front wall 52. In the present construction, the first and second arcuate recesses 42, 50 are rotationally offset by approximately half of a revolution (i.e., 180 degrees), and extend about approximately the same circumference of a circle. In other constructions, the first and second arcuate recesses 42, 50 can be rotationally offset by less than half of a revolution (e.g., 175 degrees, 160 degrees, 145 degrees, etc.), and can extend about different circumferences.

The housing 16 is further provided with an intermediate wall 48 disposed within the first arcuate recess 42 and dividing the first arcuate recess 42 into a first rotational zone 78 (FIG. 7) and a second rotational zone 80 (FIG. 10). The second rotational zone 80 receives the resistance subassembly 60, which includes a slider 28 and a biasing member (e.g., a coil spring 36). The slider 28 includes arcuate slider sidewalls 82, 84 and a slider front wall 86 (FIG. 7). The spring 36 resides at least partially within a cavity 29 formed by slider sidewalls 82, 84 and the slider front wall 86, and biases the slider 28 toward the intermediate wall 48.

When the slider front wall 86 is in contact with the intermediate wall 48, the slider front wall 86 defines a forward boundary (i.e., with respect to the forward direction of rotation) of the first rotational zone 78. Likewise, when the slider front wall 86 is in contact with the intermediate wall 48, the slider front wall 86 further defines a rearward boundary of the second rotational zone 80.

When the mandrel 18 is coupled to the housing 16, the first mating surface 21 aligns with and abuts the second mating surface 41. The first arcuate recess 42 receives the first arcuate protrusion 62 and the second arcuate recess 50 receives the second arcuate protrusion 70. As best shown in FIG. 5, the intermediate wall 48 further includes a cutout or slot 76 having a radial width W2 (FIG. 7) nominally greater than the radial width W1 of the narrow portion 68 of the first arcuate protrusion 62. As will be discussed further below, when the mandrel 18 is rotated relative to the housing 16, the narrow portion 68 permits the first arcuate protrusion 62 to pass from the first rotational zone 78 through the intermediate wall 48 and into the second rotational zone 80.

Referring back to FIG. 6, the housing 14 further includes the female square output recess 14 formed in a distal end of the housing 14 and configured to receive the male square input member (not shown) of the torque transducer 120 (FIG. 1). The output recess 14 can be of a standard square drive size (e.g., ¼″, ⅜″, ½″ ¾″, etc.). In the present construction, the torque adapter 10 further includes an adapter 12 receivable into the output recess 14 and configured to adapt the size of the square drive connection (e.g., from ¾″ to ½″, etc.) to suit variously sized input members.

In operation, to measure the stall torque of a rotary power source (e.g., the rotary power tool 110), the torque adapter 10 is positioned between the rotary power tool 110 and the torque transducer 120 according to the arrangement of FIG. 1. The shank 24 is rotatably locked to the chuck 11 of the rotary power tool 110, and the output recess 14 of the housing 16 receives the input member (not shown) of the torque transducer 120 to rotatably lock the housing 16 to the input of the torque transducer 120. The mandrel 18 is set at a starting rotational orientation relative to the housing 16 as shown in FIG. 7. At the starting orientation, the first protrusion back wall 66 abuts the first recess back wall 46, and the second protrusion back wall 74 abuts the second recess back wall 54. The spring 36 biases the slider 28 toward the intermediate wall 48 such that the slider front wall 86 abuts the intermediate wall 48.

With the torque adapter 10 in position and set to the starting orientation, the rotary power tool 110 begins supplying a torque to the torque adapter 10, which causes the mandrel 18 to begin rotating relative to the housing 16. The torque transducer 120 begins measuring the torque supplied by the torque adapter 10 at continuous intervals. The first arcuate protrusion 62 begins advancing from the starting orientation through the first rotational zone 78, through which the mandrel 18 faces only nominal rotational resistance (e.g., nominal frictional resistance between the mating surfaces 21, 41 of the flange 20 and housing 16, respectively). While the first arcuate protrusion 62 passes through the first rotational zone 78, the chuck 11 and the mandrel 18 angularly accelerate. The lack of significant rotational resistance through the first rotational zone 78 allows the rotary power tool 110 to initially overcome internal sources of rotational resistance (e.g., friction losses in an electric motor, a drivetrain assembly, etc.) before stall occurs and the stall torque is measured. Accelerating the chuck 11 and the mandrel 18 through the first rotational zone 78 prior to stalling the rotary power tool 110 provides a more accurate measurement of the stall torque.

With reference to FIG. 8, the mandrel 18 rotates through the first rotational zone 78 until it reaches an intermediate orientation where the first protrusion front wall 64 contacts the slider front wall 86. In the present construction, the first rotational zone 78 provides approximately 30 degrees of rotation of the mandrel 18 relative to the housing 16, indicated by angle ϕ1 in FIG. 7. In other constructions, the first rotational zone 78 may provide an angle ϕ1 of approximately 10 degrees, 15 degrees, 20 degrees, 25 degrees, 35 degrees, 40 degrees, 45 degrees, 50 degrees, 60 degrees, 75 degrees, or 90 degrees, depending on the sizes and dimensions of the first and second protrusions 62, 70, and the first and second recesses 42, 50.

After reaching the intermediate orientation, the mandrel 18 begins to encounter increasing rotational resistance as it rotates relative to the housing 16 through the second rotational zone 80. The first protrusion front wall 64 presses against the slider front wall 86 and compresses the spring 36. As the spring 36 compresses, it exerts an increasing amount of resistive force against the first arcuate protrusion 62 via the slider 28. The resistive force of the biasing member 36 slows the angular acceleration of the mandrel 18 and causes the mandrel 18 to decelerate relative to the housing 16.

Eventually the resistive force exerted by the biasing member 36 matches the torque provided by the rotary power tool 110, and a final “stalled” orientation is reached at which the chuck 11 and the mandrel 18 cease rotation relative to the housing 16. When the stalled orientation is reached, the torque measured by the torque transducer 120 is a stall torque of the rotary power tool 110. By rotating the mandrel 18 through the angles ϕ1 and ϕ2 before stopping at the stalled orientation, the rotary power tool 110 overcomes the internal static frictional forces associated with an initial “startup” before supplying the stall torque measured by the torque transducer 120. This provides for a more accurate measurement of the stall torque of the rotary power tool 110.

In some applications, as shown in FIG. 9, the stall torque of a particular rotary power tool 110 may be less than the resistive force exerted by the spring 36, so that the stalled orientation is reached before the second protrusion front wall 72 contacts the second recess front wall 52. In other applications, as shown in FIG. 10, the stall torque of a particular rotary power tool 110 may be equal to or greater than the resistive force exerted by the spring 36, so that the stalled orientation is reached when the second protrusion front wall 72 contacts the second recess front wall 52. In the present construction, the second rotational zone 80, indicated by angle ϕ2 in FIG. 10, provides a maximum of approximately 30 degrees of rotation of the mandrel 18 relative to the housing 16 through which the first protrusion 62 compresses spring 36. In other constructions, the second rotational zone 80 may provide a maximum angle ϕ2 of approximately 10 degrees, 15 degrees, 20 degrees, 25 degrees, 35 degrees, 40 degrees, 45 degrees, 50 degrees, 60 degrees, 75 degrees, or 90 degrees, depending on the sizes and dimensions of the first and second protrusions 62, 70, and the first and second recesses 42, 50.

FIG. 10 illustrates a method of a method 1000 of measuring a stall torque of a rotary power tool 110 using the torque adapter 10. As shown at step 1002, the torque adapter 10 is initially positioned and coupled between the rotary power tool 110 and the torque transducer 120. Next, at step 1004, the torque adapter 10 is set at a starting orientation whereat the first protrusion back wall 66 of the mandrel 18 abuts the first recess back wall 46 of the housing 16. At step 1006, the rotary power tool 110 is activated to begin supplying a torque to the mandrel 18. At step 1008, the mandrel 18 is rotated relative to the housing 16 through the first rotational zone 78 while facing nominal rotational resistance. At step 1010, the mandrel 18 is next rotated through the second rotational zone 80 while facing increased rotational resistance, due to the resistive force exerted by the spring 36. At step 1012, rotation of the mandrel 18 is stalled when the rotational resistance reaches an equivalent of the torque supplied by the rotary power tool 110. Finally, at step 1014, a stall torque value is measured by the torque transducer 120 while the rotary power source 110 is stalled.

Various features of the invention are set forth in the following claims.

What is claimed is:

1. A torque adapter for measuring a stall torque supplied by a rotary power source, the torque adapter comprising:
a housing including an arcuate recess defined at least partly by a recess front wall and a recess back wall, the arcuate recess having a first rotational zone bounded on one side by the recess front wall, and a second rotational zone bounded on an opposite side from the first rotational zone by the recess back wall;
a mandrel rotatable relative to the housing and having a flange portion, the flange portion including an arcuate protrusion received in the arcuate recess;
a resistance subassembly including a biasing member received in the arcuate recess;
wherein when the mandrel is rotated relative to the housing, the mandrel encounters nominal rotational resistance while the arcuate protrusion passes through the first rotational zone, and wherein the mandrel encounters increasing rotational resistance while the arcuate protrusion passes through the second rotational zone.

2. The torque adapter of claim 1, wherein the arcuate recess extends at least partially about a circumference of a circle, and wherein the arcuate protrusion extends at least partially about a circumference of a circle.

3. The torque adapter of claim 1, wherein the housing further includes an intermediate wall disposed in the arcuate recess between the recess front wall and the recess back wall.

4. The torque adapter of claim 3, wherein the arcuate protrusion includes a narrow portion and the intermediate wall includes a slot that permits the narrow portion to pass by the intermediate wall when the mandrel is rotated relative to the housing.

5. The torque adapter of claim 4, wherein the intermediate wall divides the first rotational zone from the second rotational zone, and the resistance subassembly is disposed in the second rotational zone.

6. The torque adapter of claim 5, wherein the resistance subassembly includes a slider having a slider front wall, and when the arcuate protrusion is located in the first rotational zone, the slider front wall abuts the intermediate wall.

7. The torque adapter of claim 6, wherein the biasing member biases the slider toward the recess back wall.

8. The torque adapter of claim 6, wherein the slider includes a first arcuate sidewall and a second arcuate sidewall, and the biasing member resides at least partially within a cavity defined by the first and second arcuate sidewalls and the slider front wall.

9. The torque adapter of claim 1, wherein the resistance subassembly causes the increasing rotational resistance by exerting an increasing resistive force against the arcuate protrusion when the arcuate protrusion passes through the second rotational zone.

10. The torque adapter of claim 1, wherein the arcuate protrusion includes a protrusion front wall and a protrusion back wall, and wherein when the arcuate protrusion passes through the first rotational zone from a starting orientation at which the protrusion back wall abuts the recess back wall, the mandrel rotates at least fifteen degrees relative to the housing before contact with the resistance subassembly.

11. The torque adapter of claim 10, wherein when the arcuate protrusion passes through the second rotational zone, the mandrel is capable of rotating a maximum of at least fifteen degrees relative to the housing while encountering increasing rotational resistance provided by the resistance subassembly.

12. The torque adapter of claim 1, wherein the housing further includes a first connector disposed in the housing and operable to mate with a corresponding second connector on a torque transducer to rotationally lock the housing to the torque transducer.

13. The torque adapter of claim 12, further including an adapter configured to adapt the size of the first connector to the size of the second connector.

14. The torque adapter of claim 1, wherein the arcuate recess is a first arcuate recess, the recess front wall is a first recess front wall, and the recess back wall is a first recess back wall, and the arcuate protrusion is a first arcuate protrusion having a first protrusion front wall and a first protrusion back wall; and
wherein the housing further includes a second arcuate recess having a second recess front wall and a second recess back wall, and the mandrel further includes a second arcuate protrusion positioned in the second arcuate recess, the second arcuate protrusion having a second protrusion front wall and a second protrusion back wall.

15. The torque adapter of claim 14, wherein the mandrel is configurable in a starting orientation relative to the housing, and wherein in the starting orientation, the first protrusion back wall abuts the first recess back wall, and the second protrusion back wall abuts the second recess back wall.

16. The torque adapter of claim 15, wherein the mandrel is further configurable in a stalled orientation relative to the housing, and wherein in the stalled orientation, one of:
a rotational resistance caused by a resistive force exerted by the biasing member is equal to the stall torque supplied by the rotary power source, such that the second protrusion front wall does not contact the second recess front wall; and
a rotational resistance caused by a resistive force exerted by the biasing member is less than the stall torque supplied by the rotary power source, such that the second protrusion front wall contacts and abuts the second recess front wall.

17. The torque adapter of claim 16, wherein the resistance subassembly includes a slider having a slider front wall, and the mandrel is further configurable in an intermediate orientation relative to the housing, wherein in the intermediate orientation, the slider front wall abuts both of the first protrusion front wall and the intermediate wall.

18. The torque adapter of claim 1, wherein the mandrel further includes a spindle portion adjacent the flange portion, and a hexagonal shank at a distal end of the spindle portion.

19. A method of measuring a stall torque supplied by a rotary power source using a torque adapter and a torque transducer, the torque adapter having a mandrel and a housing, the mandrel being coupled to the rotary power source, and the housing being rotationally fixed to the torque transducer, the method comprising:
activating the rotary power source to supply a torque to the mandrel;
rotating the mandrel relative to the housing through a first rotational zone of nominal rotational resistance;
rotating the mandrel relative to the housing through a second rotational zone of increasing rotational resistance;
stalling rotation of the mandrel when the rotational resistance becomes equal to the torque supplied by the rotary power source; and
measuring the stall torque of the rotary power source with the torque transducer.

20. The method of claim 19, further comprising:
before activating the rotary power source, setting the torque adapter at a starting orientation at which a back wall of a first arcuate protrusion of the mandrel abuts a back wall of a first arcuate recess of the housing.
